(19) United States
(12) Patent Application Publication
(10) Pub. No.: US 2025/0388145 A1
(43) Pub. Date: Dec. 25, 2025

(54) SEAT FRAME

(71) Applicant: TOYOTA BOSHOKU KABUSHIKI KAISHA, Aichi (JP)

(72) Inventors: Yushi SHINOZAKI, Toyota-shi (JP); Yuya AKAI, Miyoshi-shi (JP); Taiichiro GOTO, Toyota-shi (JP)

(73) Assignee: TOYOTA BOSHOKU KABUSHIKI KAISHA, Aichi (JP)

(21) Appl. No.: 19/240,519

(22) Filed: Jun. 17, 2025

(30) Foreign Application Priority Data
Jun. 21, 2024 (JP) 2024-100263

(51) Int. Cl. B60N 2/68

(52) U.S. Cl. CPC B60N 2/682

(57) ABSTRACT

To provide a seat frame of a vehicle seat. A seat frame of the present disclosure includes a first frame and a second frame. When a planar range of the first frame including a joint portion with the second frame is defined as a first joining range, and a planar range of the second frame including a joint portion with the first frame is defined as a second joining range, at least a part of a portion of an outer edge of the first joining range overlapping an outer edge of the first frame is located outside an outer edge of the second joining range, and a portion of the second frame outside the outer edge of the second joining range is separated farther from the first frame than the second joining range.

### CROSS-REFERENCE TO RELATED APPLICATIONS

The present application claims priority based on Japanese Patent Application No. 2024-100263 filed to Japanese Patent Office on Jun. 21, 2024, and the content of Japanese Patent Application No. 2024-100263 is incorporated by reference in its entirety.

### BACKGROUND

The present disclosure relates to a frame used for a vehicle seat.

For example, as described in Japanese Unexamined Patent Application Publication No. 2022-167380, the seat frame is formed by joining a plurality of frames by welding or the like.

### SUMMARY

The present disclosure discloses an example of a seat frame capable of reducing each joining defect.

A seat frame of a vehicle seat including a first frame and a second frame joined to the first frame desirably includes at least one of the following components, for example.

The components are that at least a part of a portion of an outer edge of a first joining range overlapping an outer edge of the first frame is located outside an outer edge of a second joining range, and a portion of the second frame outside the outer edge of the second joining range is separated farther from the first frame than the second joining range.

The first joining range is a planar range of the first frame including a joint portion with the second frame and facing the second frame. The second joining range is a planar range of the second frame including a joint portion with the first frame and facing the first frame.

As a result, it is possible to bring the first joining range and the second joining range into close contact with each other without any gap, so that the first joining range and the second joining range can be reliably joined.

That is, in a case where the first frame and the second frame are joined by welding or the like, it is desirable that joining work is performed in a state where the joint surfaces are in close contact with each other without any gap.

However, for example, in a case where a “burr” or the like is present at the end portion of the joint surface, a gap may be generated between the joint surfaces due to the “burr”.

In order to handle this, in the seat frame, at least a part of the portion of the outer edge of the first joining range overlapping the outer edge of the first frame is located outside the outer edge of the second joining range, and the portion of the second frame outside the outer edge of the second joining range is separated farther from the first frame than the second joining range.

Therefore, even if there is a “burr” or the like at the end portion of the joint surface, a gap between the joint surfaces, which is caused by the “burr”, is not generated. As a result, it is possible to bring the first joining range and the second joining range into close contact with each other without any gap, so that the first joining range and the second joining range can be reliably joined.

The seat frame may have, for example, the following configuration.

The second joining range desirably includes a protruding portion protruding toward the first frame.

### BRIEF DESCRIPTION OF THE DRAWINGS

An example embodiment of the present disclosure will be described below with reference to the accompanying drawings, in which:

FIG. 1 is a diagram illustrating a back frame;

FIG. 2 is an exploded diagram of a part A in FIG. 1;

FIG. 3 is a diagram illustrating a configuration of a joint portion A; and

FIG. 4 is an enlarged view of a part B in FIG. 3.

### DETAILED DESCRIPTION OF EXEMPLARY EMBODIMENTS

The following “embodiments of the present invention” illustrate examples of embodiments falling within the technical scope of the present disclosure. That is, the matters specifying the invention and the like described in the claims are not limited to the specific configurations, structures and the like described in the following embodiments.

The present embodiment is an example of a back frame of a seat (hereinafter, referred to as vehicle seat) mounted on a vehicle such as a vehicle. Arrows indicating directions, oblique lines, and the like attached to the individual drawings are described in order to facilitate understanding of the relationship between the individual drawings, the shape of members or portions, and the like.

The back frame is not limited to the directions illustrated in the drawings. The directions illustrated in the individual drawings are directions in a state where the vehicle seat according to the present embodiment is assembled to a vehicle. The view with oblique lines does not necessarily show a cross-sectional view.

At least one member or portion described with at least a reference sign is provided unless otherwise noted such as “only one”. That is, when there is no description such as “only one”, two or more members may be provided. The back frame disclosed in the present disclosure includes at least one of components such as members or portions described with at least reference signs and structural portions shown in the drawings.

### First Embodiment

### 1. Outline of Back Frame

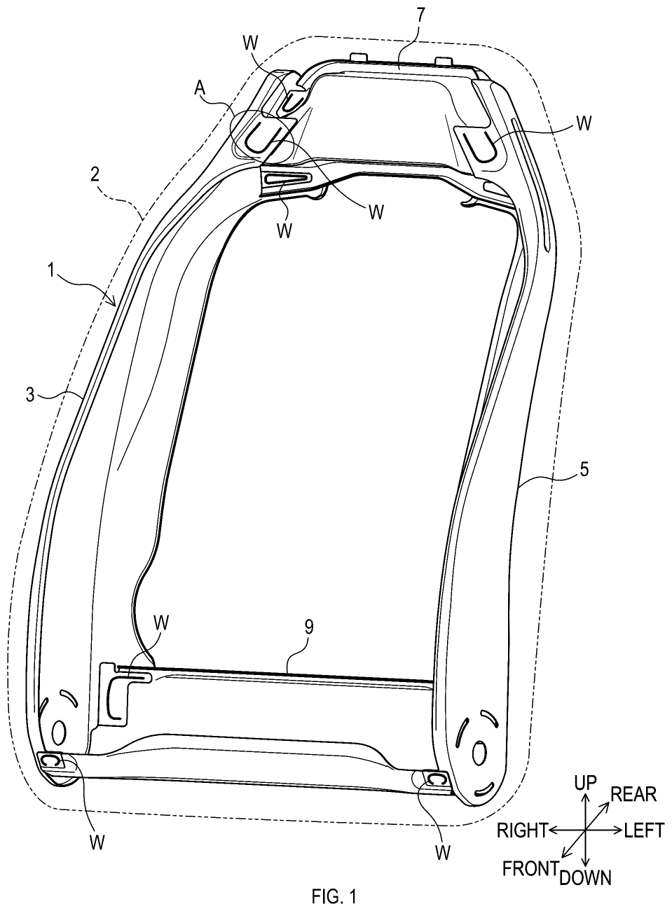

As illustrated in FIG. 1, a back frame 1 is a frame-shaped frame constituting the framework of a seat back 2. The seat back 2 is a portion for supporting the back of a sitter.

The back frame 1 includes a first side frame 3, a second side frame 5, an upper frame 7, and a lower frame 9. The first side frame 3 and the second side frame 5 are strength members extending substantially in the vertical direction.

The second side frame 5 is disposed at a position shifted from the first side frame 3 in a seat width direction (in FIG. 1, to the left side). The upper frame 7 is a strength member extending in the seat width direction and connecting the upper end side of the first side frame 3 and the upper end side of the second side frame 5.

The lower frame 9 is a strength member extending in the seat width direction and connecting the lower end side of the first side frame 3 and the lower end side of the second side frame 5. The first side frame 3, the second side frame 5, the upper frame 7, and the lower frame 9 are made of metal.

The frames are joined by welding (in the present embodiment, laser welding). A thick solid line W illustrated in FIG. 1 indicates a welding mark by laser welding. A welding operator (including an automatic welding machine) performs welding by irradiating laser beams from a front surface side.

### 2. Details of Joint Portion

The following description relates to the joint portion A in FIG. 1. Since another joint portion is the same as the joint portion A, the description of another joint portion is omitted. In the following description, the first side frame 3 is referred to as a first frame 3, and the upper frame 7 is referred to as a second frame 7.

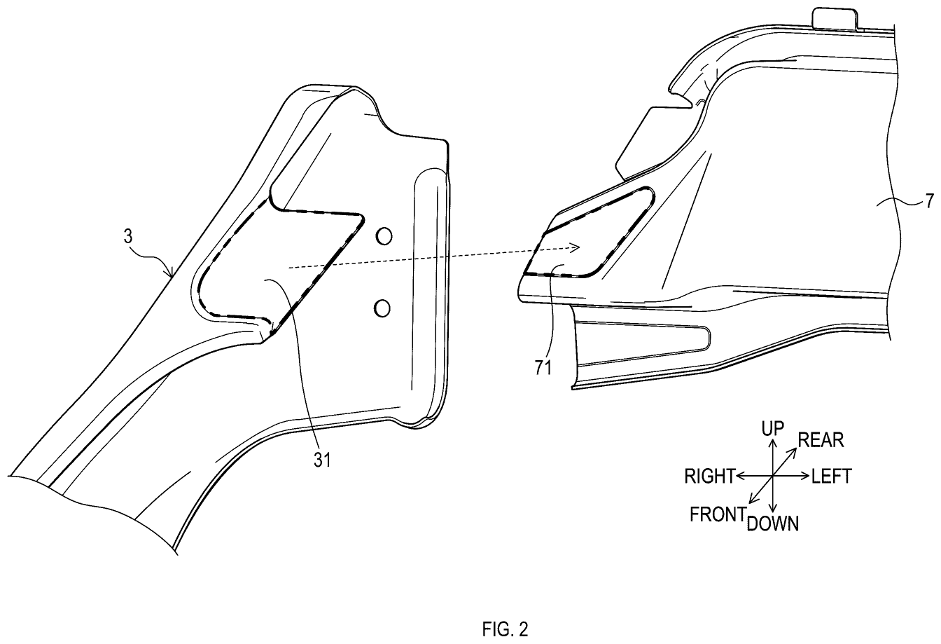

As illustrated in FIG. 2, the joint portion A includes a first joining range 31 and a second joining range 71. The first joining range 31 is a planar range including a joint portion with the second frame 7 in the first frame 3, and is a range surrounded by a two-dot chain line facing the second frame 7.

The second joining range 71 is a planar range including a joint portion with the first frame 3 in the second frame 7, and is a range surrounded by a two-dot chain line facing the first frame 3.

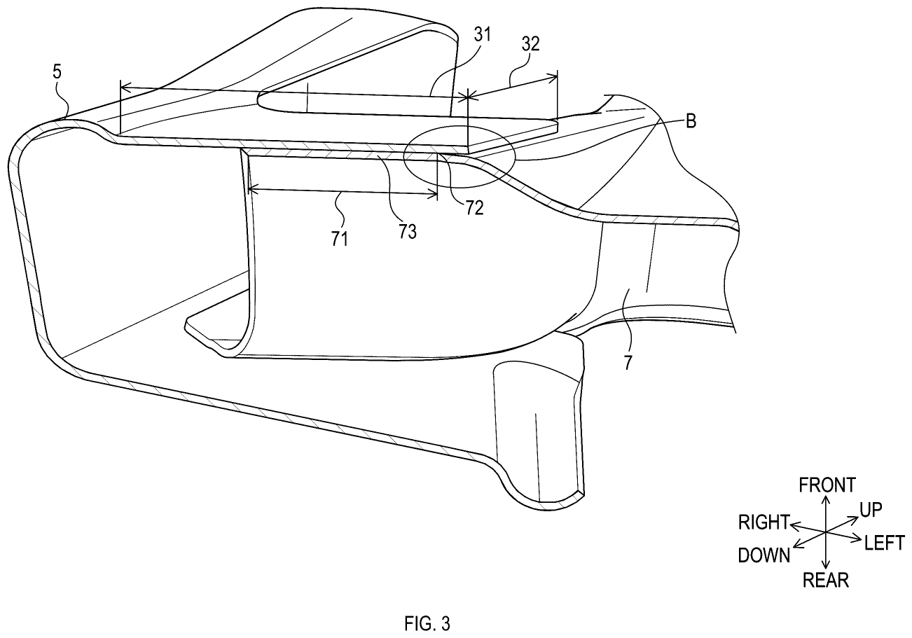

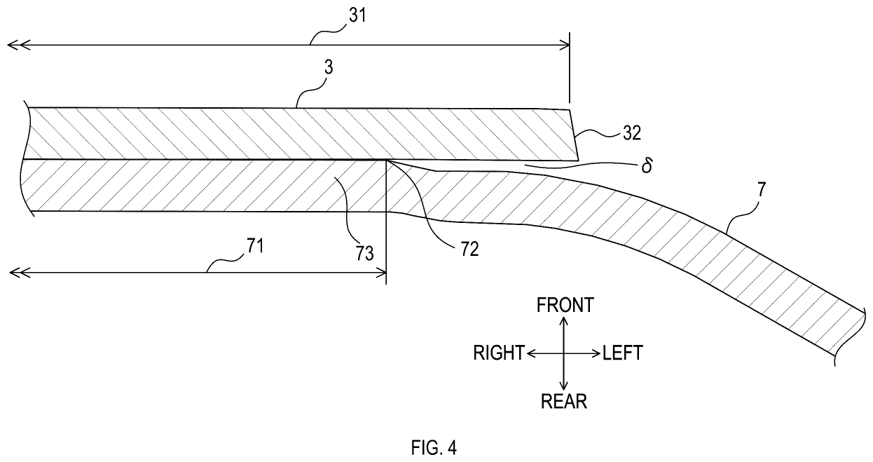

As illustrated in FIG. 3, a portion 32 that is the outer edge of the first joining range 31 and overlaps the outer edge of the first frame 3 is located outside an outer edge 72 of the second joining range 71, and a portion of the second frame 7 outside the outer edge 72 of the second joining range 71 is separated farther from the first frame 3 than the second joining range 71 as illustrated in FIG. 4.

Specifically, the second joining range 71 includes a protruding portion 73 protruding toward the first frame 3, that is, toward the first joining range 31. Therefore, a gap 8 is present between the outer edge 32 of the first joining range 31 and the second frame 7.

### 3. Characteristics of Back Frame

At the joint portion A of the back frame 1, as illustrated in FIG. 4, the outer edge 32 of the first joining range 31 is located outside the outer edge 72 of the second joining range 71, and a portion of the second frame 7 outside the outer edge 72 of the second joining range 71 is separated farther from the first frame 3 than the second joining range 71.

As a result, it is possible to bring the first joining range 31 and the second joining range 71 into close contact with each other without any gap, so that the first joining range 31 and the second joining range 71 can be reliably joined.

That is, in a case where the first frame 3 and the second frame 7 are joined to each other, it is desirable that joining work is performed in a state where the joint surfaces are in close contact with each other without any gap. However, for example, in a case where a “burr” or the like is present at the end portion of the joint surface, a gap is generated between the joint surfaces due to the “burr”.

For example, if there is a “burr” protruding toward the second joining range 71 at the outer edge 32 of the first joining range 31, and the outer edge 32 of the first joining range 31 is located inside the outer edge 72 of the second joining range 71, the “burr” is present at a position opposing the second joining range 71.

Therefore, in this configuration, since the “burr” of the first joining range 31 comes into contact with the second joining range 71, the first joining range 31 floats from the second joining range 71, and thus the first joining range 31 and the second joining range 71 cannot be brought into close contact with each other without any gap.

On the other hand, in the back frame 1, the outer edge 32 of the first joining range 31 is located outside the outer edge 72 of the second joining range 71, and the portion of the second frame 7 outside the outer edge 72 of the second joining range 71 is separated farther from the first frame 3 than the second joining range 71.

Therefore, even if there is a “burr” protruding toward the second joining range 71 at the outer edge 32 of the first joining range 31, a gap caused by the “burr” is not generated. As a result, it is possible to bring the first joining range 31 and the second joining range 71 into close contact with each other without any gap, so that the first joining range 31 and the second joining range 71 can be reliably joined.

### Other Embodiments

In the embodiment described above, the first frame 3 and the second frame 7 are joined by laser welding. However, the present disclosure is not limited thereto. For example, the first frame 3 and the second frame 7 may be joined with an adhesive.

In the above embodiment, an example of the vehicle seat has been described. However, the application of the invention disclosed herein is not limited thereto. For example, the present invention can also be applied to seats used for vehicles such as railway vehicles, ships, and aircrafts, and stationary seats used in theaters, homes, and the like.

Furthermore, the present disclosure is not limited to the embodiments described above as long as it meets the gist of the disclosure described in the embodiments. Therefore, a configuration in which at least two of the plurality of embodiments described above are combined, or a configuration in which any of the components illustrated in the drawings or the components described with reference signs in the embodiments is eliminated may be used.

What is claimed is:

1. A seat frame of a vehicle seat, comprising:
a first frame and a second frame joined to the first frame, wherein
when a planar range of the first frame including a joint portion with the second frame and facing the second frame is defined as a first joining range, and
a planar range of the second frame including a joint portion with the first frame and facing the first frame is defined as a second joining range,
at least a part of a portion of an outer edge of the first joining range overlapping an outer edge of the first frame is located outside an outer edge of the second joining range, and
a portion of the second frame outside the outer edge of the second joining range is separated farther from the first frame than the second joining range.

2. The seat frame according to claim 1, wherein the second joining range includes a protruding portion protruding toward the first frame.
